(19) United States
(12) Patent Application Publication
(10) Pub. No.: US 2025/0246369 A1
(43) Pub. Date: Jul. 31, 2025

(54) MULTILAYER ELECTRONIC COMPONENT

(71) Applicant: SAMSUNG ELECTRO-MECHANICS CO., LTD., Suwon-si (KR)

(72) Inventors: Seung Yeon Lee, Suwon-si (KR); Woo Jin Lee, Suwon-si (KR); Yong Koo Kim, Suwon-si (KR); Dong Su Cho, Suwon-si (KR); Ji Won Kim, Suwon-si (KR); Sung Hyung Kang, Suwon-si (KR)

(73) Assignee: SAMSUNG ELECTRO-MECHANICS CO., LTD., Suwon-si (KR)

(21) Appl. No.: 18/960,565

(22) Filed: Nov. 26, 2024

(30) Foreign Application Priority Data
Jan. 31, 2024 (KR) 10-2024-0015010

(51) Int. Cl. H01G 4/012; H01G 4/008; H01G 4/30

(52) U.S. Cl. CPC H01G 4/012; H01G 4/008; H01G 4/30

(57) ABSTRACT

A multilayer electronic component includes first and second surfaces opposing each other in the first direction, third and fourth surfaces connected to the first and second surfaces and connected to each other in a second direction, and fifth and sixth surfaces connected to the first to fourth surfaces and opposing each other in a third direction; a body including a dielectric layer and internal electrodes alternately disposed with the dielectric layer in the first direction, and auxiliary electrodes spaced apart from the internal electrodes and disposed on both sides in the third direction of the internal electrodes; and external electrodes disposed on the body. One of the auxiliary electrodes includes oxide regions including oxide on an end in the third direction.

### CROSS-REFERENCE TO RELATED APPLICATION(S)

The application claims benefit of priority to Korean Patent Application No. 10-2024-0015010 filed on Jan. 31, 2024 in the Korean Intellectual Property Office, the disclosure of which is incorporated herein by reference in its entirety.

### BACKGROUND

### 1. Field

The present disclosure relates to a multilayer electronic component.

### 2. Description of Related Art

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. As electronic devices such as computers and mobile devices have been designed to have a reduced size and a high output, the demand for a reduced size and high capacitance of a multilayer ceramic capacitor has also been increased.

Also, as application to automotive electrical components has increased, high reliability may be necessary in various environments.

Generally, a multilayer ceramic capacitor may be manufactured by laminating and pressing ceramic green sheets on which internal electrodes are printed, and performing cutting and sintering processes. The portion in which internal electrodes are printed and the portion in which internal electrodes are not printed may have a step difference formed by the thickness of the internal electrode pattern, and the step difference may become large as the number of laminated layers increases.

Also, in relation to a difference in material filling ratios between the portion in which internal electrodes are printed and the portion in which internal electrodes are not printed, thermal stress due to the difference in thermal expansion coefficient may occur intensively in the portion in which the internal electrode is not printed during a cooling process after a sintering process, and accordingly, cracks or delamination defects may occur.

### SUMMARY

An embodiment of the present disclosure is to provide a multilayer electronic component having improved reliability.

An embodiment of the present disclosure is to provide a multilayer electronic component in which a step difference in a margin portion is addressed.

An embodiment of the present disclosure is to provide a multilayer electronic component in which cracks and delamination are prevented.

According to an embodiment of the present disclosure, a multilayer electronic component includes first and second surfaces opposing each other in the first direction, third and fourth surfaces connected to the first and second surfaces and connected to each other in a second direction, and fifth and sixth surfaces connected to the first to fourth surfaces and opposing each other in a third direction; a body including a dielectric layer and internal electrodes alternately disposed with the dielectric layer in the first direction, and auxiliary electrodes spaced apart from the internal electrodes and disposed on both sides in the third direction of the internal electrodes; and external electrodes disposed on the body. One of the auxiliary electrodes includes oxide regions including oxide on an end in the third direction.

According to an embodiment of the present disclosure, a multilayer electronic component includes first and second surfaces opposing each other in the first direction, third and fourth surfaces connected to the first and second surfaces and connected to each other in a second direction, and fifth and sixth surfaces connected to the first to fourth surfaces and opposing each other in a third direction; a body including a dielectric layer and internal electrodes alternately disposed with the dielectric layer in the first direction, and auxiliary electrodes spaced apart from the internal electrodes and disposed on both sides in the third direction of the internal electrodes; and external electrodes disposed on the body. The internal electrodes include a first internal electrode spaced apart from the fourth surface and connected to the third surface and a second internal electrode spaced apart from the third surface and connected to the fourth surface. The auxiliary electrodes include a first auxiliary electrode disposed on each of both sides in the third direction of the first internal electrode and a second auxiliary electrode disposed on each of both sides in the third direction of the second internal electrode. The first auxiliary electrode is spaced apart from the fourth surface and connected to the third surface. The second auxiliary electrode is spaced apart from the third surface and connected to the fourth surface. The first auxiliary electrode and the second auxiliary electrode partially overlap each other in the first direction.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is a diagram illustrating region K1 in FIG. 3 according to an embodiment of the present disclosure;

FIG. 5 is a plan diagram illustrating a first internal electrode and a first auxiliary electrode according to an embodiment of the present disclosure;

FIG. 6 is a plan diagram illustrating a second internal electrode and a second auxiliary electrode according to an embodiment of the present disclosure;

FIG. 7 is an exploded perspective diagram illustrating a body in FIG. 1;

FIG. 8 is an image of a cross-section taken along line II-II′ in FIG. 1 using a scanning electron microscope;

FIG. 9 is an enlarged and scanned image of an auxiliary electrode in FIG. 8;

FIG. 10 is a scanned image of a W-T cross-section of comparative example 1; and

FIG. 11 is a scanned image of a W-T cross-section of comparative example 2.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope in the embodiment are defined only by appended claims, appropriately interpreted, along with the full range of equivalents to which the claims are entitled.

In the drawings, the same elements will be indicated by the same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like, of the description, are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a thickness (T) direction, the second direction may be defined as a length (L) direction, and the third direction may be defined as a width (W) direction.

### Multilayer Electronic Component

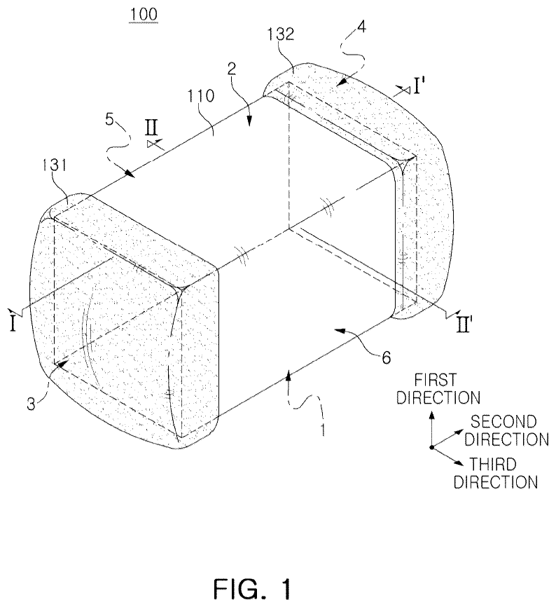

FIG. 1 is a perspective diagram illustrating a multilayer electronic component according to an embodiment.

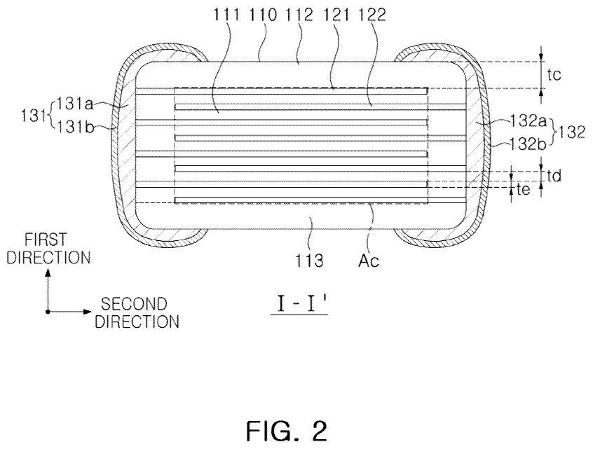

FIG. 2 is a cross-sectional diagram taken along line I-I′ in FIG. 1.

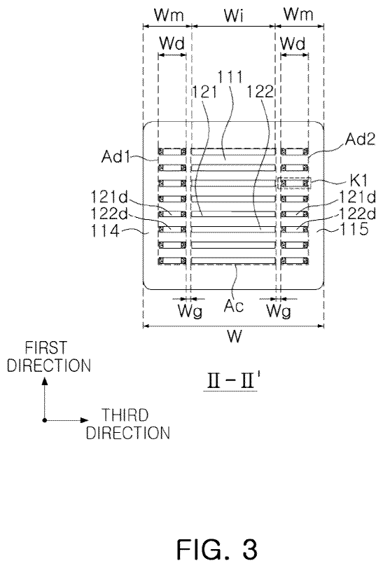

FIG. 3 is a cross-sectional diagram taken along line II-II′ in FIG. 1.

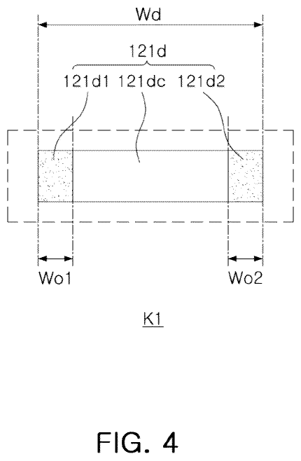

FIG. 4 is a diagram illustrating region K1 in FIG. 3 according to an embodiment.

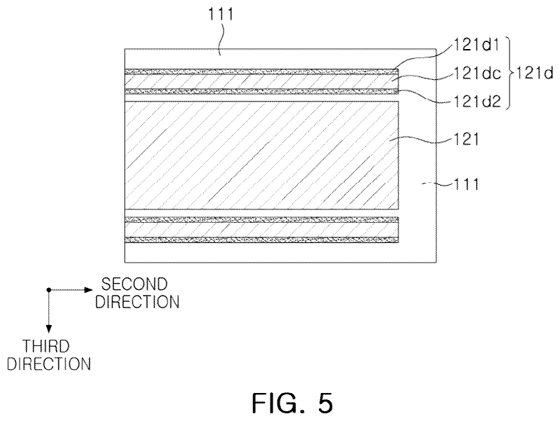

FIG. 5 is a plan diagram illustrating a first internal electrode and a first auxiliary electrode according to an embodiment.

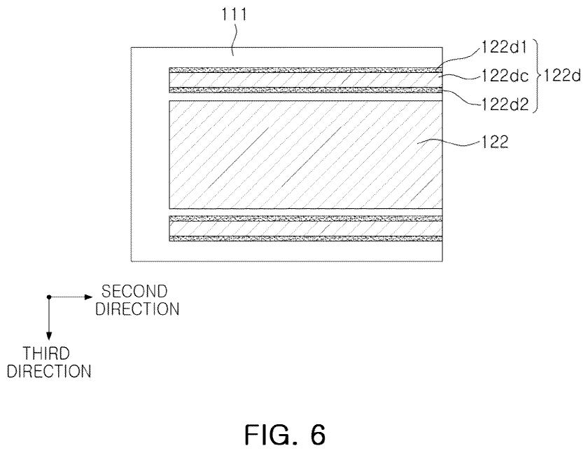

FIG. 6 is a plan diagram illustrating a second internal electrode and a second auxiliary electrode according to an embodiment.

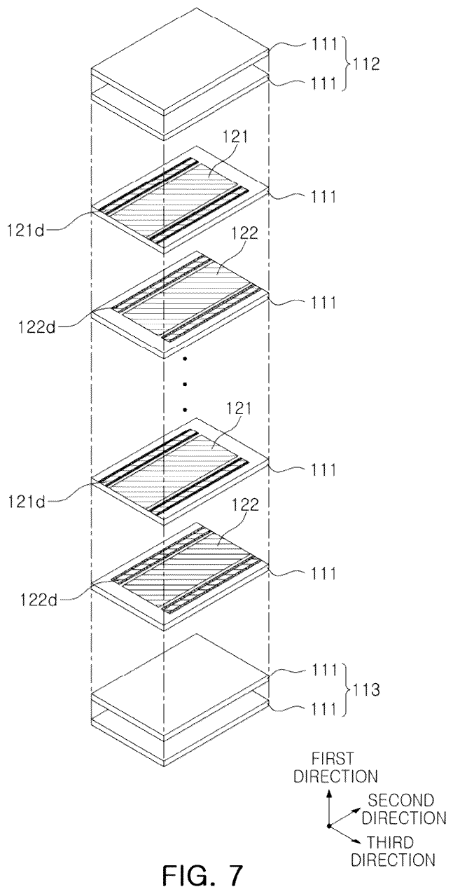

FIG. 7 is an exploded perspective diagram illustrating a body in FIG. 1.

Hereinafter, a multilayer electronic component 100 according to an embodiment will be described in greater detail with reference to FIGS. 1 to 7. A multilayer ceramic capacitor will be described as an example of a multilayer electronic component (hereinafter, MLCC), but an embodiment thereof is not limited thereto, and the multilayer ceramic capacitor may be applied to various multilayer electronic components, such as an inductor, a piezoelectric element, a varistor, or a thermistor.

The multilayer electronic component 100 may include first and second surfaces 1 and 2 opposing each other in the first direction, third and fourth surfaces 3 and 4 connected to the first and second surfaces 1 and 2 and connected to each other in a second direction, and fifth and sixth surfaces 5 and 6 connected to the first to fourth surfaces 1 to 4 and opposing each other in a third direction; a body including a dielectric layer 111 and internal electrodes 121 and 122 alternately disposed with the dielectric layer in the first direction, and auxiliary electrodes 121d and 122d spaced apart from the internal electrodes and disposed on both sides in the third direction of the internal electrodes 121 and 122; and external electrodes 131 and 132 disposed on the body. The auxiliary electrode includes oxide regions 121d1, 121d2, 122d1, and 122d2 including oxide on an end in the third direction.

Generally, a multilayer ceramic capacitor may be manufactured by laminating and pressing ceramic green sheets on which internal electrodes are printed, and performing cutting and sintering processes. The portion in which the internal electrodes are printed and the portions in which the internal electrodes are not printed may have a step difference formed by the thickness of the internal electrode pattern, and the step difference may become larger as the number of laminated layers increases.

Also, in relation to a difference in material filling ratios between the portion in which internal electrodes are printed and the portion in which internal electrodes are not printed, thermal stress due to the difference in thermal expansion coefficients may occur intensively in the portion in which the internal electrode is not printed during a cooling process after a sintering process, and accordingly, cracks or delamination defects may occur.

According to an embodiment, by disposing an auxiliary electrode on both sides in the width direction of the internal electrode and including an oxide region including an oxide on an end in the third direction of the auxiliary electrode, cracks and delamination may be prevented.

Hereinafter, each component included in the multilayer electronic component 100 according to an embodiment will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first and second surfaces 1 and 2 and the third and fourth surfaces 3 and 4 and opposing each other in the third direction. The first surface 1 may be a mounting surface disposed to oppose a substrate when mounted on the substrate.

As the margin region in which the internal electrodes 121 and 122 are not disposed overlaps the dielectric layer 111, a step difference may be formed by a thickness of internal electrodes 121 and 122, and a corner connecting the first surface to the third to fifth surface and/or a corner connecting the second surface to the third to fifth surface may have a shape shrinking toward a center in the first direction of the body 110 when viewed from the first surface or the second surface. Alternatively, due to shrinkage behavior during a process of sintering the body, the corners connecting the first surface 1 to the third to sixth surfaces 3, 4, 5, and 6 and/or the corners connecting the second surface 2 to the third to sixth surfaces 3, 4, 5, and 6 may have a shape shrinking toward a center in the first direction of the body 110 when viewed from the first surface or the second surface. Alternatively, to prevent chipping defects, the corners connecting the surfaces of the body 110 may be rounded by performing a specific process. Accordingly, the corners connecting the first surface to the third to sixth surface and/or the corners connecting the second surface to the third to sixth surface may have a rounded shape.

The plurality of dielectric layers 111 forming the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

The dielectric layer 111 may be formed by preparing a ceramic slurry including ceramic powder, an organic solvent, an additive, and a binder, preparing a ceramic green sheet by coating the slurry on a carrier film drying the slurry, and firing the ceramic green sheet. The ceramic powder is not limited to any particular example as long as sufficient electrostatic capacitance may be obtained. For example, powder based on barium titanate (BaTiO₃) and paraelectric powders based on CaZrO₃ may be used as ceramic powder. The ceramic powder may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). The paraelectric powder based on CaZrO₃ may be (Ca₁₋ₓSrₓ)(Zr_{1-y}Ti_{y})O₃ (0<x<1, 0<y<1).

Accordingly, the dielectric layer 111 may include one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), Ba(Ti_{1-y}Zr_{y})O₃ (0<y<1) and (Ca₁₋ₓSrₓ)(Zr_{1-y}Ti_{y})O₃ (0<x<1, 0<y<1). In an embodiment, the dielectric layer 111 may include (Ca₁₋ₓSrₓ)(Zr_{1-y}Ti_{y})O₃ (0<x<1, 0<y<1) as a main component.

When a magnetic material is applied instead of a dielectric material to the body 110, the multilayer electronic component may function as an inductor. The magnetic material may be, for example, ferrite and/or metal magnetic particles. When the multilayer electronic component functions as an inductor, the internal electrode may be a coil-shaped conductor.

Also, when a piezoelectric material is applied instead of a dielectric material to the body 110, the multilayer electronic component may function as a piezoelectric device. The piezoelectric material may be, for example, PZT (lead zirconate titanate).

Also, when a ZnO-based material or a SiC-based material is applied instead of a dielectric material to the body 110, the multilayer electronic component may function as a varistor, and when a spinel-based material is applied instead of a dielectric material to the body 110, the multilayer electronic component may function as a thermistor.

That is, by appropriately changing the material or structure of the body 110, the multilayer electronic component 100 according to an embodiment may function as a multilayer ceramic capacitor and also an inductor, a piezoelectric device, a varistor, or a thermistor.

The body 110 may include a capacitance formation portion Ac forming capacitance including the first internal electrode 121 and the second internal electrode 122 disposed in the body 110 and opposing each other with the dielectric layer 111 therebetween, and cover portions 112 and 113 formed in upper and lower portions of the capacitance formation portion Ac in the first direction.

Also, the capacitance formation portion Ac may contribute to forming capacitance of the capacitor, and may be formed by repeatedly laminating the plurality of first and second internal electrodes 121 and 122 with the dielectric layer 111 interposed therebetween.

The cover portions 112 and 113 may include an upper cover portion 112 disposed on an upper portion in the first direction of the capacitance formation portion Ac and a lower cover portion 113 disposed on a lower portion in the first direction of the capacitance formation portion Ac.

The upper cover portions 112 and the lower cover portions 113 may be formed by laminating a single dielectric layer or two or more dielectric layers on the upper and lower surfaces of the capacitance formation portion Ac in the thickness direction, respectively, and may prevent damages to the internal electrode due to physical or chemical stress.

The upper cover portions 112 and the lower cover portions 113 may not include an internal electrode and may include the same material as that of the dielectric layer 111.

That is, the upper cover portions 112 and the lower cover portions 113 may include a ceramic material, for example, a barium titanate (BaTiO₃) ceramic material.

The thickness of the cover portions 112 and 113 may not be limited to any particular example. For example, a thickness tc of the cover portions 112 and 113 may be 200 μm or less.

The average thickness tc of the cover portions 112 and 113 may indicate the size in the first direction, and may be an average value of the size in the first direction of the cover portions 112 and 113 measured at five points at an equal distance in the upper portion or the lower portion of the capacitance formation portion Ac.

Also, the margin portions 114 and 115 may be disposed on side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the ceramic body 110 in the width direction.

The margin portions 114 and 115 may indicate a region between both ends of the first and second internal electrodes 121 and 122 and the boundary surface of the body 110 in a cross-section in the width-thickness (W-T) direction of the body 110 as illustrated in FIG. 3.

The margin portions 114 and 115 may basically prevent damages to the internal electrode due to physical or chemical stress.

Auxiliary electrodes 121d and 122d may be disposed in the margin portions 114 and 115.

The internal electrodes 121 and 122 may include first and second internal electrodes 121 and 122. The first and second internal electrodes 121 and 122 may be alternately disposed to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, Ti and alloys thereof, but an embodiment thereof is not limited thereto.

The average thickness td of the dielectric layer 111 may not be limited to any particular example, and may be, for example, 0.1 μm to 10 μm. The average thickness te of the internal electrodes 121 and 122 may not be limited to any particular example, and may be, for example, 0.05 μm to 3.0 μm. Also, the average thickness td of the dielectric layer 111 and the average thickness te of the internal electrodes 121 and 122 may be arbitrarily determined according to desired properties or applications. For example, in the case of a miniature IT electronic component, to implement miniaturization and high capacitance, the average thickness td of the dielectric layer 111 may be 0.4 μm or less, and the average thickness te of the internal electrodes 121 and 122 may be 0.4 μm or less.

The average thickness td of the dielectric layer 111 and the average thickness te of the internal electrodes 121 and 122 may indicate the sizes of the dielectric layer 111 and the internal electrodes 121 and 122 in the first direction, respectively. The average thickness td of the dielectric layer 111 and the average thickness te of the internal electrodes 121 and 122 may be measured by scanning the cross-sections of the body 110 in the first and second directions using a scanning electron microscope (SEM) at 10,000 magnification. More specifically, the average thickness of the dielectric layer 111 may be measured by measuring the thickness at multiple points of the dielectric layer 111, for example, 30 points at equal distances in the second direction. Also, the average thickness of the internal electrodes 121 and 122 may be measured by measuring the thickness at multiple points of one of the internal electrodes 121 and 122, for example, 30 points at an equal distance in the second direction. The 30 points at equal distance may be designated in the capacitance formation portion. Meanwhile, by measuring the average value on 10 dielectric layers 111 and 10 internal electrodes 121 and 122, and the average thickness of the dielectric layer 111 and the average thickness of the internal electrodes 121 and 122 may be further generalized.

The auxiliary electrodes 121d and 122d may be spaced apart from the internal electrodes 121 and 122 and may be disposed on both sides in the third direction of the internal electrodes 121 and 122. That is, the auxiliary electrodes 121d and 122d may be disposed on the margin portions 114 and 115 and may be disposed on the same plane as the internal electrodes 121 and 122. The auxiliary electrodes 121d and 122d may be disposed on the margin portions 114 and 115 and may alleviate the step difference caused by the thickness of the internal electrode, and may reduce thermal stress after sintering, thereby preventing cracks on the margin portion.

The auxiliary electrode 121d and 122d may include oxide regions 121d1, 121d2, 122d1, and 122d2 including oxide on an end in the third direction. Since the auxiliary electrode 121d and 122d includes oxide regions 121d1, 121d2, 122d1, and 122d2, coupling force with the dielectric layer 111 may be improved, thereby preventing cracks and delamination. Also, the auxiliary electrode 121d and 122d may be disposed adjacent to the outer surface of the body such that the auxiliary electrode 121d and 122d may be vulnerable to moisture penetration, but since the auxiliary electrode 121d and 122d includes the oxide regions 121d1, 121d2, 122d1, and 122d2, reliability degradation due to moisture penetration may be prevented.

To alleviate the step difference due to the thickness of the internal electrode, when the dielectric material is applied to the region in which the internal electrode pattern is not printed after the internal electrode pattern is printed on the ceramic green sheet, an additional process of applying the dielectric material may be necessary, such that productivity may be reduced. According to an embodiment, the auxiliary electrodes 121d and 122d may be formed by printing simultaneously with the internal electrode pattern without adding another process, such that the step difference due to the thickness of the internal electrode may be prevented without reducing productivity.

In an embodiment, when the average width in the third direction of the auxiliary electrodes 121d and 122d is defined as Wd, and the average width in the third direction of the oxide regions 121d1, 121d2, 122d1, and 122d2 is defined as Wo, 0.09≤Wo/Wd≤0.5 may be satisfied. Accordingly, the effect of preventing cracks and delamination caused by the auxiliary electrode may be improved.

When Wo/Wd is less than 0.09, the effect of preventing cracks and delamination may be insufficient because the oxide region is relatively small, and when Wo/Wd exceeds 0.5, the internal electrode may also be oxidized, such that capacitance per unit volume of the multilayer electronic component may be reduced.

Referring to FIG. 4, Wo may be a sum of the average width in the third direction Wo1 of the oxide region 121d1 disposed at one end in the third direction and the average width in the third direction Wo2 of the oxide region 121d2 disposed on the other end in the third direction.

The numerical range of Wd may not be limited to any particular example, and for example, Wd may be 0.1-100 μm. In this case, Wo may be controlled to satisfy 0.09≤Wo/Wd≤0.5.

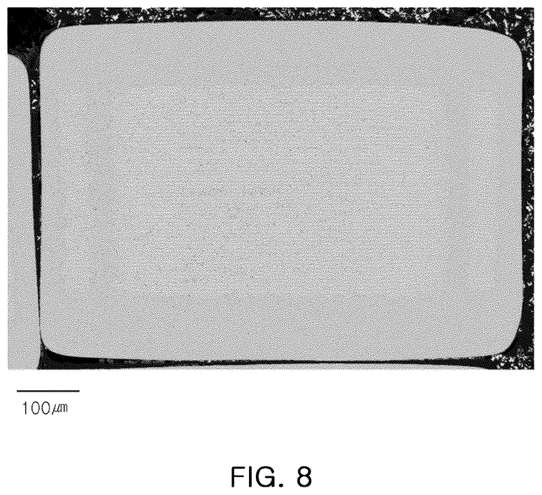

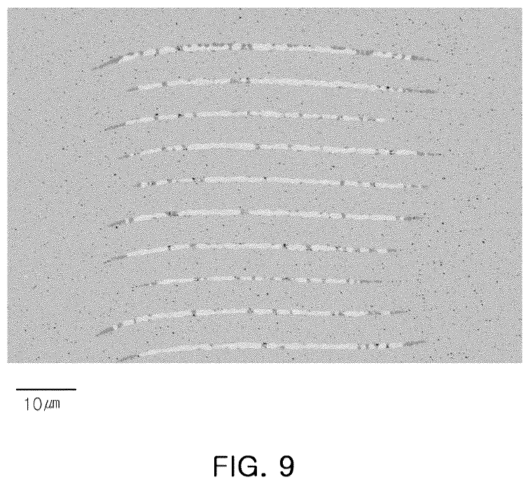

FIG. 8 is an image of a cross-section taken along line II-II′ in FIG. 1 using a scanning electron microscope. FIG. 9 is an enlarged and scanned image of an auxiliary electrode in FIG. 8.

A method for measuring Wd and Wo will be described with reference to FIGS. 8 and 9. Wd and Wo may be measured by observing the cross-sections in the first and third directions cut from a center in the second direction of the body using a scanning electron microscope (SEM). As indicated in FIG. 9, an oxide region may be disposed on an end of the auxiliary electrode in the embodiment. The region may be observed to be darker than the non-oxide region in the SEM image, and the oxide region and the non-oxide region may be distinct from each other with the naked eye. Accordingly, the oxide region may be distinct using an image program, and width Wo′ of the oxide region and the width Wd′ of the auxiliary electrode may be measured.

As indicated in Table 1 below, width Wo′ of the oxide region and width Wd′ of the auxiliary electrode may be measured from each of the nine dummy electrodes, and Wo′/Wd′ may be calculated. The arithmetic mean values for Wo′, Wd′, and Wo′/Wd′ may be determined as Wo, Wd, and Wo/Wd, respectively.

TABLE 1

| | Wo′ (nm) = | | |
|---|---|---|---|
| No. | Wo1 + Wo2 | Wd′ (nm) | Wo′/Wd′ |
| 1 | 9614.65 | 57986.64 | 0.17 |
| 2 | 6882.89 | 51505.21 | 0.13 |
| 3 | 3400.25 | 48084.43 | 0.07 |
| 4 | 5294.4 | 53974.43 | 0.10 |
| 5 | 5856.47 | 48659.49 | 0.12 |
| 6 | 5593.36 | 52385.42 | 0.11 |
| 7 | 7445.76 | 48579.85 | 0.15 |
| 8 | 7337.36 | 40814.51 | 0.18 |
| 9 | 8195.85 | 52534.96 | 0.16 |
| Average | 6624.55 | 50502.77 | 0.13 |

To observe the effect of preventing cracks and delamination due to oxide region formation, the multilayer ceramic capacitor in FIG. 8 was used as an inventive example, and comparative examples 1 and 2 in which auxiliary electrodes were included but the auxiliary electrode does not include an oxide region on an end in the third direction were prepared, and whether cracks are formed were observed. The formation of an oxide region in the auxiliary electrode was controlled by adjusting firing conditions. As for the inventive example, a firing process was performed in a weakly reducing atmosphere, and as for comparative examples 1 and 2, a firing process was performed in a strongly reducing atmosphere.

For 26 samples of each of the inventive example and comparative examples 1 and 2, cracks and delamination were observed, and the number of samples in which cracks and delamination occurred is listed in Table 2 below.

Cracks and delamination were confirmed by observing the cross-sections in the first and third direction cut from the center in the second direction of the body using an optical microscope. When cracks of 1 μm or more were observed or the gap between layers was 1 μm or more, the sample was determined to be defective, and the number of defective samples was listed.

TABLE 2

| | oxide region of | |
|---|---|---|
| Classification | auxiliary electrode | cracks and delamination |
| inventive example | ◯ | 0/26 |
| comparative example 1 | X | 16/26 |
| comparative example 2 | X | 17/26 |

Referring to Table 2, in the inventive example in which the auxiliary electrode included an oxide region, cracks and delamination did not occur in any of the 26 sample chips.

In comparative examples 1 and 2 in which the auxiliary electrode did not include an oxide region, the rate of occurrence of cracks and delamination exceeded 60%.

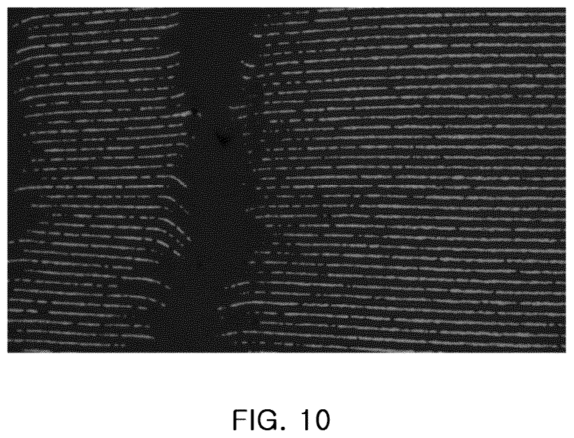

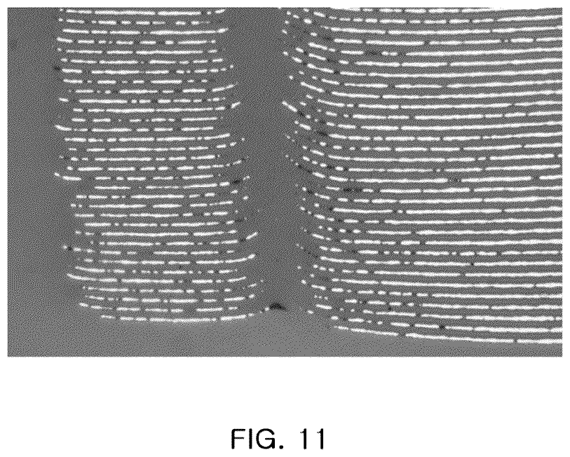

FIG. 10 is a scanned image of a W-T cross-section of comparative example 1. FIG. 11 is a scanned image of a W-T cross-section of comparative example 2. As indicated in FIGS. 10 and 11, in comparative examples 1 and 2, cracks of 1 μm or more were observed between the auxiliary electrode and the internal electrode, or the gap between layers was 1 μm or more.

In an embodiment, the oxide region may be disposed on both one end and the other end in the third direction of the auxiliary electrode. However, an embodiment thereof is not limited thereto, and in an embodiment, the oxide region may be disposed only one of one end or the other end in the third direction of the auxiliary electrode.

In an embodiment, the area fraction occupied by the oxide in the auxiliary electrode may be 10% or more and 40% or less. A region other than the oxide region in the auxiliary electrode may also include oxide, but the area fraction occupied by the oxide in the region other than the oxide region is limited, and accordingly, auxiliary capacitance may be formed in the auxiliary electrode. For example, the area fraction occupied by the oxide in the central portion of the auxiliary electrode may be less than 10%. Here, the central portion of the auxiliary electrode may indicate a region positioned in the middle when the auxiliary electrode is divided into five portions in the third direction. More preferably, the area fraction occupied by the oxide in the central portion of the auxiliary electrode may be less than 5%.

The area fraction occupied by the oxide in the auxiliary electrode may be obtained using the SEM image. Referring to FIG. 9, since the oxide may be clearly distinct by a difference in brightness in the SEM image, the area fraction may be calculated by the difference in brightness using an image analysis program. Also, for more accurate analysis, the area fraction may be measured by analyzing the scanned image using an SEM-EDS.

The area fraction occupied by the oxide in the ends in the third direction of the internal electrodes 121 and 122 may be less than 10%. Also, differently from the auxiliary electrodes 121d and 122d, the oxide region may not be disposed in the ends in the third direction of the internal electrodes 121 and 122. Here, the ends in the third direction of the internal electrode may indicate the regions positioned first and last when the internal electrode is divided into five portions in the third direction. More preferably, an area fraction of oxide in the ends in the third direction of the internal electrode 121 and 122 may be less than 5%.

The conductive metal included in the auxiliary electrode 121d and 122d may be one or more of Ni, Cu, Pd, Ag, Au, Pt, In, Sn, Al, Ti and an alloy thereof, but an embodiment thereof is not limited thereto. However, to easily form the auxiliary electrode 121d and 122d and the internal electrode 121 and 122 by a single printing process, the auxiliary electrode 121d and 122d may include the same conductive metal as a conductive metal included in the internal electrode 121 and 122. For example, the auxiliary electrode 121d and 122d may include Ni, and the oxide included in the auxiliary electrode 121d and 122d may be Ni oxide.

In an embodiment, the internal electrodes 121 and 122 may include a first internal electrode 121 spaced apart from the fourth surface and connected to the third surface and a second internal electrode 122 spaced apart from the third surface and connected to the fourth surface, and the auxiliary electrodes 121d and 122d may include a first auxiliary electrode 121d disposed on both sides of the first internal electrode in the third direction and a second auxiliary electrode 122d disposed on both sides of the second internal electrode in the third direction.

Accordingly, similarly to the first internal electrode 121 and the second internal electrode 122, the first auxiliary electrode 121d and the second auxiliary electrode 122d may be alternately disposed in the first direction with the dielectric layer 111 therebetween.

In an embodiment, the first auxiliary electrode 121d may be spaced apart from the fourth surface and may be connected to the third surface, and the second auxiliary electrode 122d may be spaced apart from the third surface and may be connected to the fourth surface.

Accordingly, the first auxiliary electrode 121d may be connected to the first external electrode 131, the second auxiliary electrode 122d may be connected to the second external electrode 132, and the first and second auxiliary electrodes 121d and 122d may form auxiliary capacitance formation portions Ad1 and Ad2 contributing to capacitance formation. Accordingly, according to an embodiment, since the multilayer electronic component 100 includes the auxiliary capacitance formation portions Ad1 and Ad2, capacitance per unit volume of the multilayer electronic component 100 may be improved.

In an embodiment, when the average width in the third direction of the region in which the fifth surface and the internal electrode are spaced apart from each other is defined as Wm, and the average width in the third direction of the auxiliary electrode disposed in the region in which the fifth surface and the internal electrode are spaced apart from each other is defined as Wd, 0.05≤Wd/Wm<1 may be satisfied. In this case, the average width in the third direction of the region in which the sixth surface and the internal electrode are spaced apart from each other may be substantially the same as Wm, and the average width in the third direction of the auxiliary electrode disposed between the sixth surface and the internal electrode may be substantially the same as Wd.

When Wd/Wm is 1, the auxiliary electrodes 121d and 122d may be exposed to the fifth and sixth surfaces of the body 110 such that moisture resistance reliability may be deteriorated, and when Wd/Wm is less than 0.05, the effect of preventing cracks and delamination may be insufficient.

In an embodiment, when the average width in the third direction of the region in which the fifth surface and the internal electrode are spaced apart from each other is defined as Wm, and the average width in the third direction of the region in which the internal electrode and the auxiliary electrode are spaced apart from each other in the third direction is defined as Wg, 0.03≤Wg/Wm may be satisfied.

When Wg/Wm is less than 0.03, the dummy electrode and the internal electrode may be connected due to printing blur, which may be problematic.

In an embodiment, when the average width in the third direction of the internal electrode is defined as Wi, and the average width in the third direction of the auxiliary electrode is defined as Wd, 0.03≤Wd/Wi≤0.20 may be satisfied.

When Wd/Wi exceeds 0.20, capacitance per unit volume may decrease, and when Wd/Wi is less than 0.03, the effect of preventing cracks and delamination may be insufficient.

Wm, Wg, Wd, and Wi may be measured from the cross-section in the first and third direction cut from the center in the second direction of the body 110, and may be measured from the SEM scan image as in FIG. 8, and the values may be the average value of the values measured from the nine auxiliary electrodes and internal electrodes positioned at the center in the first direction.

The method of forming oxide regions 121d1, 121d2, 122d1, and 122d2 including oxide on ends in the third direction of the auxiliary electrodes 121d and 122d is not limited to any particular example. However, even when the same paste as paste for forming the internal electrodes 121 and 122 is used, the auxiliary electrodes 121d and 122d may be disposed close to the outer surface of the body and may be greatly affected by a sintering temperature, sintering atmosphere, and heat treatment maintenance time. Therefore, by controlling the sintering temperature, sintering atmosphere, and heat treatment maintenance time, the oxide regions 121d1, 121d2, 122d1, and 122d2 may be formed, and the length thereof may be adjusted.

The external electrodes 131 and 132 may be disposed on the third and fourth surface 3 and 4 of the body 110.

The external electrodes 131 and 132 may be disposed on the third and fourth surfaces 3 and 4 of the body 110, respectively, and may include the first and second external electrodes 131 and 132 connected to the first and second internal electrodes 121 and 122, respectively.

In the embodiment, the multilayer electronic component 100 may have two external electrodes 131 and 132, but the number of the external electrodes 131 and 132 or the shape thereof may be varied depending on the shape of the internal electrodes 121 and 122 or other purposes.

The external electrodes 131 and 132 may be formed of any material having electrical conductivity, such as metal, and a specific material may be determined in consideration of electrical properties and structural stability, and the external electrodes 131 and 132 may have a multilayer structure.

For example, the external electrodes 131 and 132 may include an electrode layer disposed on the body 110 and a plating layer disposed on the electrode layer.

For a more specific example of the electrode layers 131a and 132a, the electrode layers 131a and 132a may be firing electrodes including a conductive metal and glass, or resin electrodes including a conductive metal and resin.

Also, in the electrode layers 131a and 132a, a firing electrode and a resin electrode may be formed in order on the body. Also, the electrode layers 131a and 132a may be formed by transferring a sheet including a conductive metal to the body, or may be formed by transferring a sheet including a conductive metal to the firing electrode.

A material having excellent electrical conductivity may be used as the conductive metal included in the electrode layers 131a and 132a, and is not limited to any particular example. For example, the conductive metal may be one or more of nickel (Ni), copper (Cu), and alloys thereof.

The plating layers 131b and 132b may improve mounting properties. The type of the plating layers 131b and 132b is not limited to any particular example, and may be a plating layer including one or more of Ni, Sn, Pd, and alloys thereof, and may be formed as a plurality of layers.

For a more specific example of the plating layers 131b and 132b, the plating layers 131b and 132b may be Ni plating layers or Sn plating layers, and Ni plating layers and Sn plating layers may be formed in order on the electrode layers 131a and 132a, or Sn plating layers, Ni plating layers, and Sn plating layers may be formed in order. Also, the plating layers 131b and 132b may include a plurality of Ni plating layers and/or a plurality of Sn plating layers.

The size of the ceramic electronic component 100 may not be limited to any particular example.

However, the effects of improving reliability and preventing cracks and delamination in the embodiment may be prominent in a multilayer electronic component 100 having a size of 1608 (length×width, 1.6 mm×0.8 mm) or less.

Considering manufacturing errors and external electrode sizes, when the length of the multilayer electronic component 100 is 1.7 mm or less and the width is 0.9 mm or less, the effects of improving reliability and capacity per unit volume in the embodiment may be prominent. Here, the length of the multilayer electronic component 100 may indicate the maximum size in the second direction of the multilayer electronic component 100, and the width of the multilayer electronic component 100 may indicate the maximum size in the third direction of the multilayer electronic component 100.

According to the aforementioned embodiments, by disposing the auxiliary electrodes including oxide regions on both sides in the width direction of the internal electrodes, reliability of the multilayer electronic component may be improved.

Also, the step difference of the margin portion may be addressed.

Also, cracks and delamination may be prevented.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
first and second surfaces opposing each other in the first direction, third and fourth surfaces connected to the first and second surfaces and connected to each other in a second direction, and fifth and sixth surfaces connected to the first to fourth surfaces and opposing each other in a third direction;
a body including a dielectric layer and internal electrodes alternately disposed with the dielectric layer in the first direction, and auxiliary electrodes spaced apart from the internal electrodes and disposed on both sides in the third direction of the internal electrodes; and
external electrodes disposed on the body,
wherein one of the auxiliary electrodes includes oxide regions including oxide on an end in the third direction.

2. The multilayer electronic component of claim 1, wherein, when an average width in the third direction of the auxiliary electrodes is defined as Wd and an average width in the third direction of the oxide regions is defined as Wo, 0.09≤Wo/Wd≤0.5 is satisfied.

3. The multilayer electronic component of claim 2, wherein Wd is 0.1 μm or more and 100 μm or less.

4. The multilayer electronic component of claim 1, wherein the oxide regions are disposed on both one end and the other end in the third direction of the one of the auxiliary electrode.

5. The multilayer electronic component of claim 1, wherein an area fraction of oxide in the one of the auxiliary electrodes is 10% or more and 40% or less.

6. The multilayer electronic component of claim 1, wherein the one of the auxiliary electrodes includes Ni, and the oxide is Ni oxide.

7. The multilayer electronic component of claim 1,
wherein the internal electrodes include a first internal electrode spaced apart from the fourth surface and connected to the third surface and a second internal electrode spaced apart from the third surface and connected to the fourth surface, and
wherein the auxiliary electrodes include a first auxiliary electrode disposed on each of both sides in the third direction of the first internal electrode and a second auxiliary electrode disposed on each of both sides in the third direction of the second internal electrode.

8. The multilayer electronic component of claim 7,
wherein the first auxiliary electrode is spaced apart from the fourth surface and connected to the third surface, and
wherein the second auxiliary electrode is spaced apart from the third surface and connected to the fourth surface.

9. The multilayer electronic component of claim 1, wherein, when an average width in the third direction of regions in which the fifth surface and the internal electrodes are spaced apart from each other is defined as Wm, and an average width in the third direction of the auxiliary electrodes is defined as Wd, 0.05≤Wd/Wm<1 is satisfied.

10. The multilayer electronic component of claim 1, wherein, when an average width in the third direction of regions in which the fifth surface and the internal electrodes are spaced apart from each other is defined as Wm, and an average width in the third direction of regions in which the internal electrodes and the auxiliary electrodes are spaced apart from each other in the third direction is defined as Wg, 0.03≤Wg/Wm is satisfied.

11. The multilayer electronic component of claim 1, wherein, when an average width in the third direction of the internal electrodes is defined as Wi and an average width in the third direction of the auxiliary electrodes is defined as Wd, 0.03≤Wd/Wi≤0.20 is satisfied.

12. The multilayer electronic component of claim 1, wherein an area fraction occupied by oxide in a central portion of the one of the auxiliary electrodes is less than 10%.

13. The multilayer electronic component of claim 1, wherein an area fraction occupied by oxide on both ends in the third direction of one of the internal electrodes is less than 10%.

14. A multilayer electronic component, comprising:
first and second surfaces opposing each other in the first direction, third and fourth surfaces connected to the first and second surfaces and connected to each other in a second direction, and fifth and sixth surfaces connected to the first to fourth surfaces and opposing each other in a third direction;
a body including a dielectric layer and internal electrodes alternately disposed with the dielectric layer in the first direction, and auxiliary electrodes spaced apart from the internal electrodes and disposed on both sides in the third direction of the internal electrodes; and
external electrodes disposed on the body,
wherein the internal electrodes include a first internal electrode spaced apart from the fourth surface and connected to the third surface and a second internal electrode spaced apart from the third surface and connected to the fourth surface,
wherein the auxiliary electrodes include a first auxiliary electrode disposed on each of both sides in the third direction of the first internal electrode and a second auxiliary electrode disposed on each of both sides in the third direction of the second internal electrode,
wherein the first auxiliary electrode is spaced apart from the fourth surface and connected to the third surface,
wherein the second auxiliary electrode is spaced apart from the third surface and connected to the fourth surface, and
wherein the first auxiliary electrode and the second auxiliary electrode partially overlap each other in the first direction.

15. The multilayer electronic component of claim 14, wherein, when an average width in the third direction of regions in which the fifth surface and the internal electrodes are spaced apart from each other is defined as Wm, and an average width in the third direction of the auxiliary electrodes is defined as Wd, 0.05≤Wd/Wm<1 is satisfied.

16. The multilayer electronic component of claim 14, wherein, when an average width in the third direction of regions in which the fifth surface and the internal electrodes are spaced apart from each other is defined as Wm, and an average width in the third direction of regions in which the internal electrodes and the auxiliary electrodes are spaced apart from each other in the third direction is defined as Wg, 0.03≤Wg/Wm is satisfied.

17. The multilayer electronic component of claim 14, wherein, when an average width in the third direction of the internal electrodes is defined as Wi and an average width in the third direction of the auxiliary electrodes is defined as Wd, 0.03≤Wd/Wi≤0.20 is satisfied.
